(19) United States
(12) Patent Application Publication
(10) Pub. No.: US 2026/0084364 A1
(43) Pub. Date: Mar. 26, 2026

(54) Apparatus

(71) Applicant: kocher-plastik Maschinenbau GmbH, Sulzbach / Laufen (DE)

(72) Inventors: Michael Schultes, Fichtenau (DE); Frank Mark, Spiegelberg (DE); Tobias Dorsch, Obersontheim (DE); Thomas Höglinger, Obersontheim (DE); Helmut Jacob, Ettlingen (DE); Patryk Prezyna, Fellbach (DE); Harald Reichart, Gaildrof (DE); Roland Speiser, Abtsgmünd (DE); Roland Sauter, Sulzbach-Laufen (DE); Alexander Muff, Buttisholz (CH)

(73) Assignee: kocher-plastik Maschinenbau GmbH, Sulzbach / Laufen (DE)

(21) Appl. No.: 19/110,638

(22) PCT Filed: Feb. 15, 2023
(86) PCT No.: PCT/EP2023/053730

§ 371 Date: Mar. 11, 2025

(51) Int. Cl. B29C 49/42; B29C 49/04; B29L 31/00; B67C 3/22; B67C 7/00

(52) U.S. Cl. CPC B29C 49/4278; B29C 49/04; B29C 49/4281; B67C 3/22; B67C 7/00; B29L 2031/7158; B67C 2003/227

(57) ABSTRACT

The disclosure relates to an apparatus for producing container products from plastics materials. The apparatus comprises a moulding device to which a moulding tube made of plasticised material can be supplied by extrusion, and which moulding device has moulding surfaces which are movable and reproduce a specifiable container geometry, on which the moulding tube can be placed for a shaping, filling and/or sealing process. A guiding and holding device is provided, which can be controlled such that, in at least one functional position outside the moulding region of the moulding device, guiding and holding parts act on the plastics material that surrounds the finished container products, wherein the plastics material establishes a material connection between a finished container product that has already left the moulding device and an at least partly finished container product that is still in the moulding device, can be separated by a separating device.

### CROSS-REFERENCE TO RELATED APPLICATIONS

This application is a U.S. National Stage Application of International Application No. PCT/EP2023/053730 filed Feb. 15, 2023, which designates the United States of America, the contents of which are hereby incorporated by reference in their entirety.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to an apparatus for producing container products from plastic materials, in particular by performing a blow-moulding, filling and sealing process.

EP 2 595 789 B1 discloses a method for moulding a plurality of containers from a parison, the method including the following steps:
Moving a holder and holding a tube after it emerges from the tube head of an extrusion device;
Severing the held, open tube of the parison before filling and/or sealing the containers;
Moving a first section of a mould into a first closed position around a first portion of the open parison;
Moulding a plurality of at least one portion of first containers with the first portion of the parison in the first section;
Filling or sealing the first containers;
Moving a second section of a mould into a second closed position around a second portion of the open parison; and
Moulding a plurality of at least one portion of second containers, staggered with respect to the first containers, with the second portion of the parison in the second section, the second section of the mould being integrated in the first section of the mould.

In the known solution, the tube-like parison is cut immediately before it is formed and filled, the tube cut being made immediately above the parison, which is open at the top and in this respect has a relatively large filling opening which is widened in cross-section. Fume, gases, vapours and particles (hereinafter also referred to as contaminants for short) can easily be produced or released when the tube is cut, which can result in direct contamination of the interior of the parison via the opening of the parison mentioned above and therefore contamination of the container opening and the container contents. This risk is increased by the long cutting path, which substantially corresponds to the outer diameter of the tube and can result in a relatively long cutting time. The slight deformability of the still heat-soft parison means that fast cutting is not possible, as the parison must be kept open accordingly for insertion of the filling pipes. A similar solution to this is described in WO 2007/010373 A1.

The contamination risk described at the outset due to particles or gaseous substances may be avoided by producing a wide container chain web rather than individual containers, which container chains are widely separated from each other spatially in the cooled state and are separated from each other, usually by punching, by a separating device which engages on the container chain that has emerged outside the moulding device. The production of such container chain webs by vacuum moulding is described in the generic WO 2014/060101 A1 as well as in DE 10 2008 006 073 A1 and in a post-published DE 10 2020 004564.2 of the proprietor.

In these aforementioned prior art publications, the continuous production of container chains of small volume containers, i.e., up to 20 ml filling volume, is described. In this context, “continuous” is to be understood to the effect that the delivery rate of the plastic tube from the extrusion unit remains substantially unchanged and uninterrupted during the entire manufacturing process. It goes without saying that continuous production is interrupted for maintenance purposes, mould changeover and for cleaning purposes, etc.

The aforementioned DE 10 2008 006 073 A1 also discloses an apparatus for producing vacuum-moulded container products from plastic material by means of individual mould parts extending along a production line, which can be moved towards and away from each other in pairs in order to close or open a production mould in which the container products are formed, which emerge after the demoulding process as a container chain moving along the production line, a demoulding device, which engages outside the production mould on the container chain that has emerged, being provided to support the demoulding process. This known apparatus aims to increase the production speed, as instead of a kind of single-piece process, it enables the production of a wide container chain web from a large number of contiguous containers, the container chain moving away from the moulding device along the production line and supporting vibrating movements in the outlet area of the container chain web.

Although extremely high productivity is achieved in this way, the high number of mould pairs necessary and the complex web movements required also call for high investment costs with little format flexibility. Within the short cycle time of approx. 2 to 5 seconds, it is only possible to form the containers by vacuum moulding and not by blow moulding. The possible container geometries than can be produced with this are therefore limited to small-volume containers such as ampoules and by comparison it is not readily possible to produce bottles with larger filling volumes of 50 ml, for example. Moreover, there are always numerous mould pairs and additionally numerous filled containers on the common vertical production line, which for this purpose alone requires an overall height for the production apparatus of at least 15 times the container height.

Generic WO 2014/060101 A1 discloses an apparatus for producing container products made of plastic materials, in particular by performing a blow-moulding, filling and sealing process, having a moulding device which can be fed with a moulded tube of plasticised plastic material and which has movable mould surfaces that are adapted to a predefinable container geometry, against which the moulded tube can be placed for a blow moulding, filling and sealing process, a guiding and holding device being provided, which has movable guiding and holding parts that can be controlled in such a manner that, in at least one of the possible functional positions outside the moulding area of the moulding device, said guiding and holding parts engage on the respective plastic material which at least partially surrounds the finished container products. This known apparatus minimises the apparatus complexity for producing container chain webs; however, it is no longer readily possible with it to simply produce filled containers with a higher volume of 50 ml and more, since such a container chain web, which is extremely difficult to handle because of its own intrinsic weight due to the increased filling volume, can cause the plasticised plastic tube to lengthen very significantly or even tear, which in turn is unacceptable for reasons of the sterility required for medical purposes (e.g., irrigants, solutions for infusion).

The production of container chain webs of the said type is generally associated with a further r disadvantage. As individual containers are not accessible for an inspection or for post-treatment purposes until a longer time after their production, early quality assurance inspection or post-treatment, such as rapid cooling of the container together with contents, is only possible after a delay which makes it impossible to react quickly to irregularities in production or to thermally stabilise heat-sensitive products (such as protein-containing solutions).

### SUMMARY

A need exists to provide an improved apparatus and an improved method which enable low-contamination or contamination-free production of filled and sealed containers, and furthermore open up the possibility of also producing larger containers, such as infusion bottles, with an increased filling volume compared to the usual ampoule products.

The need is addressed by the subject matter of the independent claim(s). Embodiments of the invention are described in the dependent claims, the following description, and the drawings.

### BRIEF DESCRIPTION OF THE DRAWINGS

FIG. 1 a schematically simplified perspective oblique view of example components of an example apparatus;

FIG. 2 a perspective oblique view of only a partial region of the example apparatus according to FIG. 1, the mould closing unit and the guiding and holding device as well as the separating device being shown with respectively associated functional elements;

FIG. 3 once again a perspective oblique view of only a partial region of the diagram according to FIG. 2;

FIG. 4 a perspective partial diagram of finished example container products which, as seen in the viewing direction of FIG. 4, are separated from the material connection above, not shown, in the region of the upper material connection by means of the separating device and are held in the lower region of a comparable material connection by a gripper of a handling device;

FIG. 5 partially in elevation, partially in longitudinal section, an example guiding and holding device with supporting strips and cutting blades of the separating device located underneath;

FIG. 6 a partial detail of the example apparatus according to FIG. 2 with multi-axis robot arm as part of the handling device which, according to the diagram according to FIG. 4, holds the finished example container products in a removal position by means of a gripper; and

FIG. 7 a partial diagram of a further embodiment using a vertically movable extrusion head.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the plastic material, which, formed as a card, establishes a material connection between the container product finished in the moulding device and a container product leaving the moulding device in each case via the guiding and holding device, can be severed by means of a separating device. This means that in some embodiments, it is possible to completely dispense with the known production of a parison that is wide open at the top and with the production of a container chain web by separating individual, optionally also blow-moulded, filled and sealed containers directly from the at least partially collapsed moulded tube after passing through the moulding device. In this way, the possibilities of contamination are reduced, as any contaminants which may arise during separation of the material connection cannot get into the interior of the containers. In addition, it is possible to separate the still-warm material connection with low actuating forces.

In some embodiments, it is provided that the separating device can be actuated independently of the moulding device and that a handling device, for example in the form of a robot arm, moves into a removal position for this card in such a manner that a timed manufacturing sequence of individual container products is made possible with simultaneous non-timed, i.e., continuous, emergence of the moulded tube from the extrusion head.

In this way, relatively high output rates of finished container products can be achieved. It is also ensured in this way that the separated card, which comprises a plurality of container products, cannot fall out of the apparatus in a downward direction and, in this respect, safe handling of the card within the apparatus is achieved.

For example, it can be further provided that the material connection comprises at least one further finished container product and that then two mutually adjacent container products can be separated from each other by means of the separating device. The material connection, which is usually formed of a thin-walled plastic strip between the finished and at least partially finished container product can accordingly also contain at least one further, for example finished, container product which originates from the separating device, so that in this respect the moulding device can also separate two adjacent containers in the production sequence from each other.

Since the moulding and filling of a container product unit takes place before separation, contamination of the container contents cannot occur unintentionally during the separation process. As the production and discharge relates to individual containers or container blocks with individual containers running transverse to the vertical production line, there is no need to handle a container chain web as illustrated in prior art and the apparatus according to the teachings herein can be used universally for a variety of possible container types for medical purposes from small-volume ampoules, for eye drops or inhalation solutions for example, to large-volume bottles for enteral or parenteral applications as the respective container product.

With the apparatus according to the teachings herein, high productivity is possible with a minimum number of moulds, which helps to save costs, and the possibility of quickly exchanging the individual moulds results in a high degree of format flexibility. In addition, the apparatus is small in the vertical and consequently upright production or processing direction and can therefore be implemented in a space-saving manner.

Furthermore, the container products produced and separated in this way and the contents therein can easily be post-treated, such as inspection for particulate contamination, treatment steps to reduce the bacterial count or application of a required label for the container product including cooling thereof.

Insofar as the disclosure refers to a separating device, this may be a separating or cutting unit using hot, cold or ultrasonic blades as well as a laser or other separating devices including water cutting devices and the like. Separation by the respective separating or cutting unit in a tube section that has already partially collapsed but it still warm takes place spatially, for example below the moulding device which is closed in this respect and above a filled and sealed container product unit which has already left the moulding device as a finished container product. However, it is also possible to separate two adjacent, finished container products. The separating device can be arranged within the apparatus in a stationary manner; however, it is also possible to provide a movable separating device which can be moved together with the guiding and holding device during the course of production, which will be illustrated in greater detail below. For the latter embodiment, it is provided, for example in an apparatus according to the teachings herein, that the movable guiding and holding parts can be brought into a functional position at the end of a respective blow moulding, filling and sealing process for the container product in which they bear supportively against the moulded tube on mutually opposing sides of said tube in the section adjoining the inlet of the moulding device for a holding operation, and in that the guiding and holding parts comprise the separating device which, in a separating position from the holding operation, carries out separation of the material connection.

In some embodiments, it is provided that the separating device has one or for example two optionally heatable cutting blades, of which each cutting blade is assigned to a guiding and holding part, which have a predefinable distance from each other during the holding operation, which reduces, for example to zero, for the separating cut. On the one hand, this gives the guiding and holding part the function of guiding the container product in a transfer position and on the other hand, after passing through the moulding device, the function of performing a separating cut.

In some embodiments, it is provided that the moulding device comprises jaws forming individual mould surfaces, which can be moved by means of a closing unit in a direction of movement extending perpendicular to the vertical direction of movement of the moulded tube between a mould-closing position and a position opening the mould, and that a displacement unit is provided, by means of which the closing unit can be moved vertically downwards from a starting position during the blow-moulding, filling and sealing process together with the movement of the moulded tube and upwards into the starting position after completion of the blow-moulding, filling and sealing process. This type of vertical movements enables a continuous production process to be implemented along a production line with low apparatus complexity, because only one pair of jaws with the mould surfaces is required for each moulding process. Starting from the extrusion device, this also results in a top-down production process with a separation process in a plane, extending transverse to the production line, or a vertical production plane or production line.

In some embodiments, it is provided that a handling device is present, which grips the respective finished container product by means of a gripper, at least during the separation process, and removes it from the guiding and holding device in a removal position after separation. It is for example further provided that, in the removal position, the gripper engages on a part of the material connection which, after separation, consists of the plastic material which leaves the moulding device. For example, it is provided that the handling device is part of a robot arm movable in a plurality of axes. Due to the handling device, the finished separated container products can be safely discharged from the apparatus and the handling device allows easy adjustment of the removal process for a wide variety of container products with different container volumes.

In some embodiments, it is provided that the guiding and holding device can be moved between an upper position, which corresponds to the operative position of the guiding and holding parts, and lowered positions by means of a second displacement unit. In this way, the guiding and holding parts can easily be moved into their respective intended functional position.

In some embodiments, it is provided that the guiding and holding parts are configured in the form of supporting strips, which, in the pivot position corresponding to the operative position, extend over the entire length of the mould parting line of the moulding device and, for pivot movements extending in a horizontal plane, are attached to pivot shafts of the associated actuating unit, which extend vertically and parallel to each other next to the mould parting line. The elongated strips make it easy to implement support for a correspondingly large-volume row of containers and also to reliably achieve the separation forces of the separating device for the separation process.

The disclosure further relates to a method for continuously producing container products from plastic materials, in particular by performing a blow-moulding, filling and sealing process, in particular using an apparatus as described above, container products produced one after the other in a manufacturing sequence by means of a moulding device being connected to each other via a web-like material connection, for example formed by the at least partially collapsed moulded tube, and the material connection being severed after leaving the moulding device by means of a separating device. The average thickness of the web-like material connection in the separation region should for example be less than 3 cm. In this respect, a development and improvement of the known solution according to WO 2014/060101 A1 and post-published application DE 10 2020 004 564.2 is achieved.

Some components of the apparatus and the associated manufacturing method are already described in WO 2014/060101 A1 and post-published DE 10 2020 004 564.2, incorporated by reference herein, so that in this respect reference is made to the content of these documents and only some components of the apparatus will be described in more detail below, insofar as this is necessary for understanding the solution according to the teachings herein.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are schematic and not necessarily to scale.

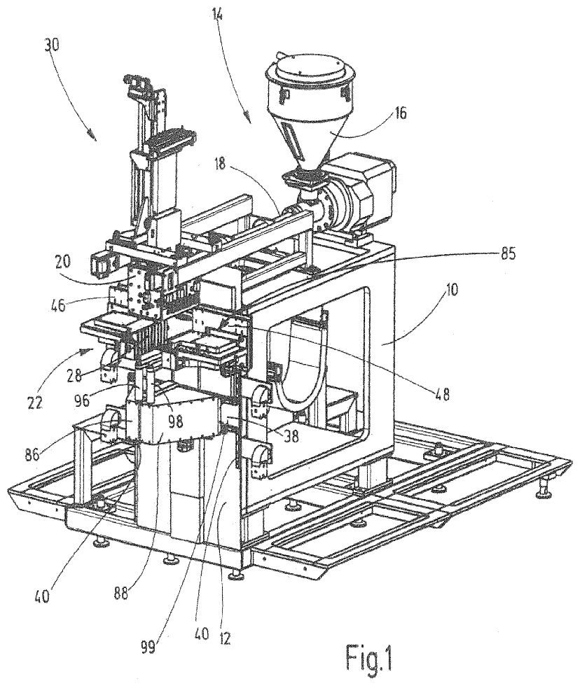

In FIG. 1, which shows an overall view of the apparatus according to some embodiments in a simplified diagram, an apparatus frame is denoted by 10, which has a rectangular box shape with a front wall 12 extending in a vertical plane. Arranged on the upper side of the box shape of the frame 10 is an extruder device denoted as a whole by 14, which is configured according to the relevant prior art and has a feed hopper 16 for the plastic granules and a motor-drivable extruder screw unit 18 to feed plasticised plastic mass to a tube or extrusion head 20. This extrudes the heated, plasticised plastic material in the form of a tube, which extends over the entire width of a moulding device 22 measured along the mould parting line. Thus, depending on the configuration of the moulding device 22, a plurality of container products 26 can be formed in one moulding step from a single extruded moulded tube, denoted by 24 in FIG. 6, corresponding to the number of mould surfaces 28 located side by side in a row.

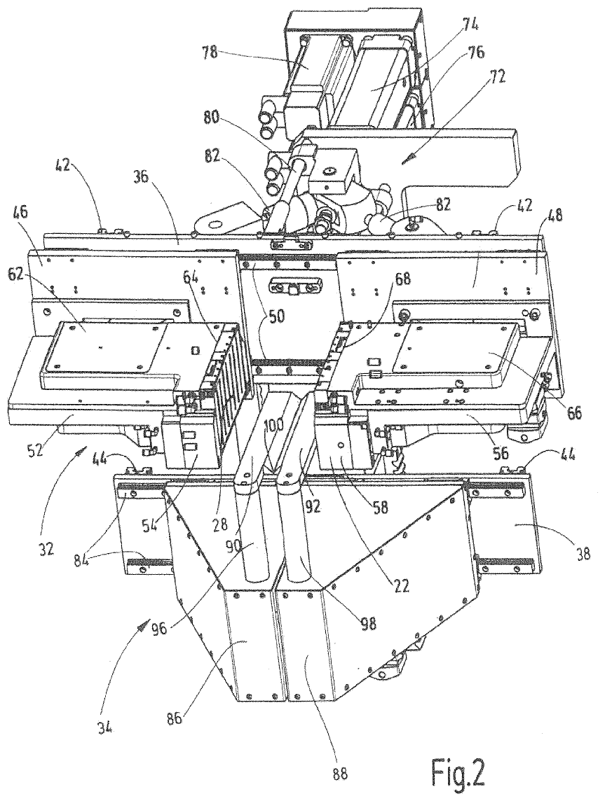

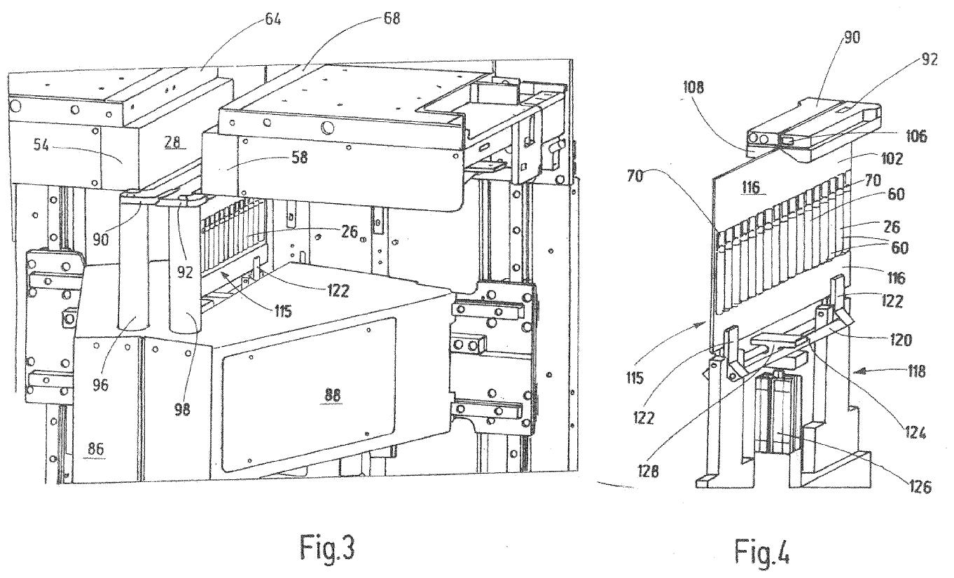

Of these, the mould surfaces 28 of the part of the moulding device 22 on the left-hand side are visible in FIGS. 1 and 2, which show the moulding device 22 in the open state. The aforementioned mould surfaces 28 are omitted in FIG. 3 for the sake of simplicity. A blowing/filling device 30 is provided along the upper side of the apparatus frame 10 for optional blow moulding and a metered supply of dispensing or filling quantities during a filling procedure of the container products 26 formed in the moulding device 22. The blowing/filling device 30 has a number of blowing/filling mandrels corresponding to the number of container products 26 to be moulded, which blowing/filling mandrels are not shown for the sake of simplicity but which correspond substantially in their construction and function to the construction described in WO 2014/060101 A1. In any case, the plastic mass is extruded through the extrusion head 20 (also described as the tube head) in such a manner that the moulded tube 24 formed surrounds the row of blowing/filling mandrels which can be lowered as a result into a blowing/filling position within the moulded tube 24 in which they blow-mould and fill the containers 26 formed between the mould surfaces 28. For moulding those parts of the container which in this respect hold the filling quantity, an expansion process is provided before filling, in which a negative pressure is applied to the container wall within the container mould in order to draw the corresponding wall parts to the mould (negative pressure gradient). In a departure from the construction described in WO 2014/060101 A1, this expansion process can also be carried out additionally or alternatively by blowing in blowing air, for example via the blowing/filling mandrels, which in this respect then serve additionally as blowing mandrels (positive pressure gradient).

In a separate diagram, FIG. 2 shows the closing unit 32 of the moulding device 22 and the guiding and holding device 34. Both the closing unit 32 and the guiding and holding device 34 each optionally have a carrier plate 36 or 38, respectively, extending in a vertical plane. As FIGS. 1 and 2 further show, the apparatus frame 10 has a vertical guide 40 on either side of the front wall 12 on the outside in each case, which vertical guide is formed from guide rails which, together with guide rails 42 on the carrier plate 36 and corresponding guide rails 44 on the further carrier plate 38, form a kind of recirculating ball track, so that the closing unit 32 and the guiding and holding device 34 are guided on the vertical guides 40 so that they can be moved in the vertical direction. Spindle drives (not shown), which are actuated by a machine control system, are provided with associated recirculating ball screws for the corresponding vertical movements.

The closing unit 32 of the moulding device 22 has a slide as a carrier for each mould half of the overall mould, of which the slide on the left-hand side in FIG. 2 is denoted by 46 and the carriage on the right-hand side is denoted by 48. The two slides 46, 48 are guided on guide strips 50 of the carrier plate 36 so as to be horizontally movable. A left-hand side main jaw 54 is attached to a holding body 52, which is fixed to the slide 46, and a right-hand side main jaw 58 is attached to a holding body 56, which is fixed to the opposing right-hand carriage 48.

In the closed position with the main jaws moved together (not shown), the main jaws 54, 58 mould the main part 60 of the container products 26, which holds the respective container contents (see FIG. 4). On the upper side of the holding body 52 of the left-hand side main jaw 54 and forming a flat plate, a holding body 62 forming a kind of slide plate is mounted so as to be horizontally displaceable, to which holding body a left-hand side head jaw 64 is attached. In a corresponding manner, on the upper side of the holding body 56 of the right-hand side main jaw 58, a further holding body 66 is arranged so as to be horizontally displaceable, which forms the carrier for a right-hand side head jaw 68. As a result, the mutually opposing head jaws 64, 68 can be moved into the closed position independently of the main mould jaws 54, 58 in order to mould the head region 70 (see FIG. 4) of the container products 26 and to close the filled containers in this respect.

For the horizontal movements between the mould closed position and the mould open position as shown in FIG. 2, a separate actuator is provided in each case for the main jaws 54, 58 and for the head jaws 64, 68, of which the actuator provided for the main jaws 54, 58 is coupled to the carrier plates 46 and 48 in order to move them along rails 50 on the carrier plate 36. The actuator assigned to the head jaws 64, 68 is linked to the holding bodies 62, 66 of the head jaws 64 and 68 respectively. Both actuators each have a lever gear mechanism 72, which are arranged one above the other, so that substantial parts of the bottom lever gear mechanism 72 are not visible in FIG. 2. However, in terms of the functional scope, it is configured identically to the visible lever gear mechanism 72 arranged above it as the drive for the head jaws 64, 68. Each of the lever gear mechanisms 72 has a spindle drive 74 and 76, respectively, as the drive, each with one associated electric drive motor 78. The spindle drives 74, 76 are connected via struts 80 to a cross member on the rear of the carrier plate 36, so that the unit formed from the lever gear mechanisms 72 and the spindle drives 74, 76 can move together with the carrier plate 36 on the vertical guide 40 corresponding to the action of the recirculating ball screws (not shown). In the position shown, connecting rods 82 linked to the upper spindle drive 74 hold the two mutually opposing head jaws 64, 68 in their open position. Corresponding steering gears are used to control the main jaw pairs 54, 58 located underneath. Using a central displacement unit 85 (FIG. 1), the closing unit 32 can be moved vertically downwards from its starting position during the blow-moulding, filling and sealing process together with the movement of the moulded tube 24 and, after completion of the blow-moulding, filling and sealing process, can be moved upwards back to the starting position. Further details regarding this can be found in WO 2014/060101 A1.

The guiding and holding device 34, its carrier plate 38, as well as the carrier plate 36 of the closing unit 32 are movable on the vertical guide 40 of the frame 10 and, in a similar manner to the carrier plate 36, have horizontal guide rails 84 on which a left-hand side actuating unit 86 and a right-hand side actuating unit 88 are guided so as to be horizontally displaceable. The actuating units 86, 88 form the actuators for associated guiding and holding parts, the actuating unit 86 actuating a first left-hand side guiding and holding part and a second left-hand side guiding and holding part, while the second actuating unit 88 actuates a first right-hand side guiding and holding part and a second right-hand side guiding and holding part. Left-hand side first guiding and holding part and right-hand side first guiding and holding part are each formed by pivotable supporting strips 90 and 92, which are configured identically and extend in a direction parallel to the direction of a mould parting line 94 (see FIG. 6) in a pivot position corresponding to their operative position. For adjusting the pivot position, each supporting strip 90, 92 is attached to an associated pivot shaft 96 and 98, respectively, which extend in the vertical direction out of the housing of the respective associated actuating unit 86 and 88 parallel to each other next to the mould parting line 94. Located in the housing of the two actuating units 86, 88, there is a pivot drive for each of the pivot shafts 86, 88 which can be actuated by a corresponding machine control system.

As FIG. 6 shows in particular, the two supporting strips 90, 92 can be pivoted away forwards out of their holding position shown in FIG. 2 by means of the respectively assignable pivot shaft 96, 98 and can then be moved upwards again over the moulding device 22, it being possible, after pivoting it back into the holding position, for the moulded tube 24 to be gripped in order to take the moulded tube 24 with it, when the moulding device 22 is open again according to the diagram of FIG. 2, into a lower holding position in which the separation process according to some embodiments takes place, which will be described in greater detail below. The guiding and holding device 34 as a whole can be moved between an upper and a lower functional position by means of a further, second displacement unit 99 (FIG. 1). Further details of this and in particular cooperation with the first displacement unit 85 are the subject matter of WO 2014/060101 A1, the disclosure of which is also the subject matter of the present intellectual property right.

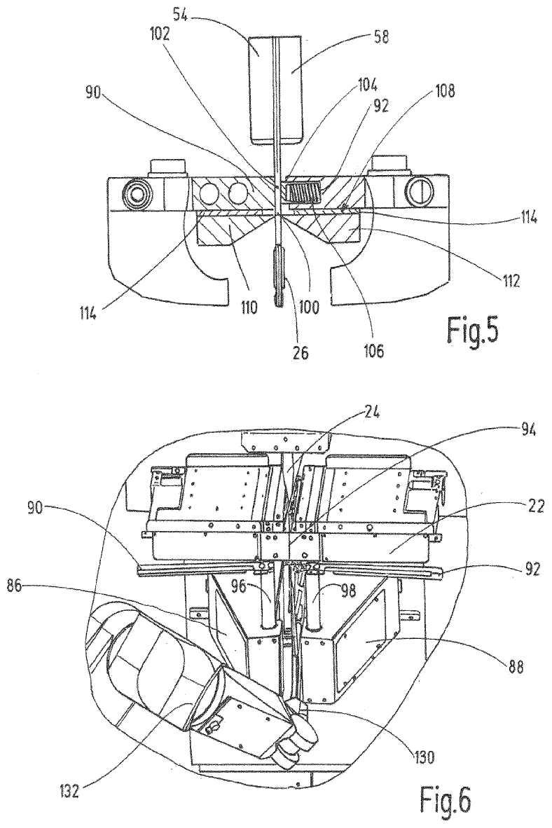

As FIG. 5 shows in particular, in the closed state the two supporting strips 90, 92 have a holding or clamping gap 100, in which a material connection 102 is fixed, between the finished container product 26, which has already left the moulding device 22 via the guiding and holding device 34, and the container product not shown, which is still located in the moulding device 22. Contrary to the diagram of FIG. 2, the two strips 90, 92 are for example provided with vertically extending contact surfaces on their mutually opposing end faces, the right-hand supporting strip 92, as viewed in the direction of FIG. 5, having a variable contact surface 104, which is supported against an energy accumulator in the form of at least one compression spring 106. In this way, the variable contact surface 104 is pressed against the material connection 102 with a predefinable contact pressure via the compression spring 106, which enables a certain amount of tolerance compensation and holds the material connection 102 securely in place.

Below the two supporting strips 90, 92, there is a separating device 108 with two cutting blades 110, 112 tapering towards each other to a point, the first cutting blade 110 being attached to the underside of the supporting strip 90 and the second cutting blade 112 being attached to the underside of the second supporting strip 92. As shown in the diagram of FIG. 5, the cutting edges of the two cutting blades 110, 112 are arranged at a distance from each other in a starting position in such a manner that, by actuating the two pivot shafts 96, 98, the holding or clamping gap 100 first has to be overcome by compressing the compression spring 106 before the separating cut through the material connection 102 is made due to the feed movement of the two cutting blades 110, 112 towards each other. In this respect too, the actual separating cut is cushioned by the spring property of the respective compression spring 106, so that a soft separation process can be performed. The blades 110, 112 can optionally be configured as vibration blades. For a better separation process, the cutting blades 110, 112, for example consisting of a metal material, can also be heated. In the aforementioned case, it is expedient to provide a plate-shaped thermal insulator 114 between the blades 110, 112 and the respectively associated supporting strip 90 and 92. It is understood that a plurality of the compression springs 106 shown in FIG. 5 can be arranged distributed over the entire length of the supporting strip 92 with the variable contact surface 104. Furthermore, the blades 110, 112 for example extend over the entire length of the respective supporting strip 90, 92, it being necessary in any case to select the length such that the entire existing material connection 102 made of plastic material is cut through. Since in this respect the separating device 108 is part of the guiding and holding device, it also follows the movement of the supporting strips 90, 92 with its two cutting blades.

As FIG. 4 shows in particular, the respective container product 26, ampoule-like in this exemplary case, is accommodated in a type of card 115 with material connection regions 116 as part of the material connection 102 above and below the finished container products 26. To illustrate the possible cutting procedure, only half the holding and separating device 108 is shown in FIG. 4. As can be seen in particular from FIG. 3, for the sake of simplicity the container products 26 produced with the moulding device 22 when open are omitted as well as the associated parts of the moulded tube 24. In this case, the separating cut is performed by a pivot movement of the pivot shafts 96 and 98, which thus move the supporting strips 90, 92 with the respective cutting blade 110 and 112 towards each other in a pivot movement in such a way that the separation process first takes place in a rear region, viewed in the direction of FIG. 3, and then continues up to a front region of the material connection 102. This improves the application of cutting forces and results in improved separation of the adjacent material connection regions 116 in the production sequence, the variable contact surface 104 securing the material connection 102 in its position until it is completely cut through. The separation process is ended by pivoting the supporting strips 90, 92 with their cutting blades 110, 112 away from each other and furthermore, the card 115 with the container products 26 is also released as a whole.

A handling device denoted as a whole by 118 is provided so that the card 115, which has been separated in this manner and comprises a plurality of container products 26, does not fall out downwards between the two actuating units 86, 88, which in this respect are held at least partially at a distance from each other. The handling device 118 has a gripper 120 which, as FIG. 4 shows, has two clamp pairs 122, the gripper tongues of which can be moved in pairs towards each other or away from each other by means of a linkage drive 124. For this purpose, a linear cylinder 126, which is for example configured as a pneumatic actuator, engages on the linkage drive 124. If the linear cylinder 126 is retracted downwards, viewed in the direction of FIG. 4, the two longitudinal rods of the linkage drive 124 are moved towards each other by means of the guide part 128 and the clamp pairs 122 with their gripper tongues are released via corresponding pivot axes. The linear cylinder 126 thus extends in the opposite direction, the maximum possible opening gap of the clamp pairs 122 decreases and the card 115 is held in place via its lower material connection region 116 by means of the gripper 120.

As FIG. 6 shows in particular, the linear cylinder 126 is held by a front arm part 130 of a customary multi-axis robot arm 132, which can remove the separated card 115 shown in FIG. 4 downwards out of the production apparatus when the left-hand and right-hand actuating units 86 and 88, respectively, are in the correspondingly open release position.

The robot arm 132 as part of the handling device 118 then allows, with corresponding machine control, a large number of post-treatment steps for the card 115 with the finished container products 26, for example introduction of the card 115 into a correspondingly suitable temperature control apparatus, in particular a cooling apparatus (not shown). A further post-treatment can consist of a quality assurance inspection, applying a label, isolating the germ-reducing treatment using heat and/or high-energy radiation, leak testing, etc. It is understood that, as part of the manufacturing sequence, the robot arm 132 moves back to its removal position for the card 115 shown in FIG. 6 as soon as such a card 115 has been separated from the container arrangement via the separating device 108. In this way, a timed manufacturing sequence of individual container products 26 with simultaneous non-timed, i.e. continuous, emergence of a moulded tube 24 from the extrusion head 20 is possible with relatively high output rates of finished container products 26.

For the sake of simplicity, the handling device 118 together with associated robot arm 132 is not shown in FIGS. 1 and 2. Moreover, the high modularity of the handling device 118 using the robot arm 132 makes it possible, if necessary, to implement a different kind of gripper 120 for removing the finished container products 26 from the apparatus.

Furthermore, as can further be seen from FIG. 3, a different separating device can also replace the separating device 108 with the two cutting blades 110, 112, for example a laser cutting device can be arranged in this region below the moulding device 22, the laser beam of which is transverse to the vertical production line with the respective material connections 102.

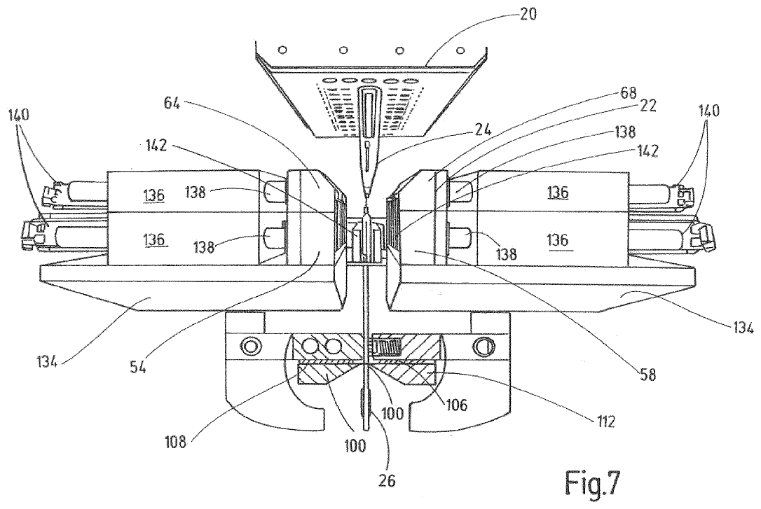

FIG. 7 shows a different kind of embodiment with an extrusion unit that can be moved in the vertical direction, as is explained in detail in post-published application DE 10 2020 004 564.2.

Disclosed herein is an apparatus for producing plastic container chains by means of a blow-fill-seal process, consisting at least of a moulding device 22 with individual jaw-like moulding tools 54, 58; 64, 68, which can be moved repeatedly relative to each other from an open receiving position to a moulding closed position, and an extrusion unit with extrusion head 20 by means of which the at least one extruded plastic tube can be introduced into the open receiving position of the moulding tools 54, 58; 64, 68, wherein, it being possible by means of a displacement device to move the extrusion unit in conjunction with each extruded plastic tube 24 in the opposing direction with respect to the moulding device 22, which is arranged in a stationary manner in each position of the moulding tools. Among other things, a carrier device, which has a horizontally aligned carrier plate with two carrier plate parts 134, which are arranged spaced mutually apart and symmetrically with respect to a moulding plane of production line extending vertically, is used to accommodate the moulding device 22. In the central region of each carrier plate part 134, two cuboid guide parts, stacked on top of each other, are provided as guide blocks 136 which are oriented towards the displacement direction of the block-like moulding tools 54, 58 and 64, 68. Each of these guide blocks 136 is used to guide two guide rods 138 each for guiding the respective moulding tool. In addition, each guide block 136 is used to guide two actuator rods, not described in greater detail, which extend between the guide rods 138 towards the displacement direction of the moulding tools 54, 58; 64, 68. In this case, the respective actuator rod can be moved electromagnetically by means of a linear drive 140.

In this embodiment, the separating device 108, which is shown in FIG. 5, is mounted in a stationary manner below the stationary moulding device 22, for example below vertically movable clamping strips 142 of a clamping device not shown here, which act as a guiding and holding device. As described above, the container products 26 separated in the material connection 102 are discharged with the aid of the gripper 120 described above, using the handling device 118 with the robot arm 132 (the latter not being shown in FIG. 7). Consequently, it is also possible in this embodiment to prevent the production of plastic container chains in a beneficial manner. In this embodiment shown, separation of the containers 26 is also carried out while they are located on the main axis or mould parting line, which corresponds to the longitudinal axis of the emerging tube 24. In the aforementioned configuration, the material connection 102 comprises at least one further, finished container product 26 after leaving the moulding device 22, so that, according to the diagram of FIG. 7, two already finished container products 26 can be separated from each other in the manufacturing sequence by means of the separating device 108, with a container product still to be finished being located in the moulding device 22.

In any case, with the apparatus according to the teachings herein, the following repetitive method steps can be carried out sequentially in time or in part simultaneously in the course of a production process:
a—Continuously extruding a moulded tube 24 through a tube or extrusion head 20,
b—Closing a moulding device 22 with application of the mould surfaces 28 around the moulded tube 24, in an application position below the extrusion head 20,
c—Moulding the respective container products 26 by means of a pressure gradient (blowing and/or vacuum) within the main jaws 54, 58, optionally performing a purging process with inert gas or similar, subsequent filling, optionally purging the head space above the filling level of the filled container 26 with inert gas or similar,
d—Sealing the filled container products 26 by the two head jaws 64 and 68 as part of the moulding device 22,
e—Gripping and collapsing the moulded tube 24 above the head jaws 64, 68 by a tube gripper, in the form of the supporting strips 90, 92 of the guiding and holding device 34 and applying the gripper 120 as a discharge means to the underside of the filled and sealed container contents in the form of a container card 115,
f—Opening the moulding device 22 and moving it upwards to the contact or starting position provided,
g—Cutting off the card 115 with the container products 26 by the separating device 108 on the tube gripper in the form of supporting strips 90, 92, opening the guiding and holding device 34 by pivoting away the two supporting strips 90, 92 and discharging the card 115 with the container products 26 by the gripper 120 using the handling device 118 with the robot arm 132, followed by moving the guiding and holding device 34 upwards into a position above the moulding device 22.

Optionally, step g—(cutting off the card 115) can take place before or at the same time as step f—(opening the moulding device 22).

Alternatively to steps e— to g—, when using a stationary moulding device 22, according to post-published application DE 10 2020 004 564.2,
h—Opening the moulding device 22 and gripping the filled container products 26 in the opened mould with the aid of a pair of clamping strips 142, and moving them downwards and applying the gripper 120 as a discharge means to the previously produced container products 26 below the pair of clamping strips 142, and cutting off the card 115 with the respective container product 26 by the separating device 108 together with discharging the card 115 with the respective container product 26 by the gripper 120 using the handling device 118 with the robot arm 132, and
i—Repeating the sequence a— to g— or alternatively the sequence a— to d— and h—.

Optionally, in step h—, cutting off the card 115 can also take place before or at the same time as the step of opening the moulding device 22.

During steps a— to g—, mould 22 and tube gripper 34, 90, 92 are moved downwards along the vertical production line in the direction of extrusion in a uniform motion similar to the exit speed of the moulded tube 24 at a constant low speed, for example at approx. 80 mm/s. In method step f—(opening the moulding device 22), the mould is opened perpendicular to this main production axis and moved upwards along the main axis at increased speed, before returning to the application position (step b—) below the extrusion head 20.

Simultaneously with continuous extrusion, the container products 26 discharged by the gripper 120 by means of the handling device 118 can be inspected or post-treated in further steps which are not described in greater detail, in particular for heat-sensitive filling materials, rapid cooling of the filled container unit as card 115, for example by blowing on a gas, immersing in a fluid cooling medium, inserting into a cooling tunnel, etc.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-21. (canceled)

22. An apparatus for producing container products made of plastic materials, having a moulding device, which can be fed with a moulded tube of plasticised plastic material using an extrusion head and which has movable mould surfaces that are adapted to a predefinable container geometry, against which the moulded tube can be placed for a blow-moulding, filling and/or sealing process, wherein a guiding and holding device is provided, which has movable guiding and holding parts that can be controlled in such a manner that, in at least one of the possible functional positions outside the moulding area of the moulding device, said guiding and holding parts engage on the respective plastic material which at least partially surrounds the finished container products, wherein the plastic material, which is formed as a card and establishes a material connection between a finished container product, which has already left the moulding device, and an at least partially finished container product, which is still located in the moulding device, can be severed by means of a separating device.

23. The apparatus of claim 22, wherein the separating device can be actuated independently of the moulding device, and wherein a handling device moves into a removal position for the card in such a manner that a timed manufacturing sequence of individual container products is made possible with simultaneous non-timed, i.e. continuous, emergence of the moulded tube from the extrusion head.

24. The apparatus of claim 22, wherein the material connection accommodates at least one further finished container product, and wherein two container products, which are adjacent to each other, can be separated from each other by the separating device.

25. The apparatus of claim 22, wherein the material connection consists of an at least partially collapsed moulded tube with an average thickness in the separation region of less than 3 cm, or less than 2 cm, or less than 1 cm.

26. The apparatus of claim 22, wherein the movable guiding and holding parts of a guiding and holding device can be brought into a functional position at the end of a respective blow-moulding, filling and sealing process for the container product in which they bear supportively against the moulded tube on mutually opposing sides of said tube in the section adjoining the inlet of the moulding device for a holding operation, and wherein the guiding and holding parts comprise the separating device which, in a separating position from the holding operation, carries out separation of the material connection.

27. The apparatus of claim 22, wherein the separating device has two cutting blades, of which each cutting blade is assigned to a guiding and holding part, which have a predefinable distance from each other during the holding operation, which reduces to less than 4 mm, or less than 2 mm, or less than 1 mm, or to zero, for the separating cut.

28. The apparatus of claim 22, wherein the moulding device comprises jaws forming individual mould surfaces, which can be moved using a closing unit in a direction of movement extending perpendicular to the vertical direction of movement of the moulded tube between a mould-closing position and a position opening the mould, and wherein a displacement unit is provided, using which the closing unit can be moved vertically downwards from a starting position during the blow-moulding, filling and sealing process together with the movement of the moulded tube and upwards into the starting position after completion of the blow-moulding, filling and sealing process.

29. The apparatus of claim 22, wherein a handling device is provided, which grips the respective finished container product in a removal position using a gripper.

30. The apparatus of claim 22, wherein the separating unit is arranged stationary or movable in the vertical direction.

31. The apparatus of claim 22, wherein the handling device is part of a multi-axially movable robot arm.

32. The apparatus of claim 22, wherein the guiding and holding device can be moved between an upper position, which corresponds to the operative position of the guiding and holding parts, and lowered positions using a second displacement unit.

33. The apparatus of claim 22, wherein the guiding and holding parts are configured in the form of supporting strips, which, in the pivot position corresponding to the operative position, extend over the entire length of the mould parting line of the moulding device and, for pivot movements extending in a horizontal plane, are attached to pivot shafts of the associated actuating unit, which extend vertically and parallel to each other next to the mould parting line.

34. The apparatus of claim 22, wherein the separating device with at least one cutting blade is mounted below an underside of the moulding device and can optionally be moved together therewith.

35. The apparatus of claim 22, wherein a blowing/filling mandrel is used to form the container products.

36. A method for producing container products from plastic materials, wherein container products produced sequentially in time using a moulding device are connected to each other via a web-like material connection, wherein the material connection is severed at a predefinable point below the moulding device by a separating device.

37. The method of claim 36, wherein the material connection is severed at an angle of 80 degrees to 110 degrees, or approximately 90 degrees, to the longitudinal axis of a moulded tube using the separating device.

38. The method of claim 36, wherein production of the moulded tube is carried out with the aid of supporting gas.

39. The method of claim 36, wherein filling of the container products is carried out by filling mandrels, which are located at least partially inside the moulded tube.

40. The method of claim 36, wherein the method is used to produce container products for medical purposes.

41. The method of claim 36, wherein moulding of the container products is carried out at least partially by a blow-moulding process.

42. A method for producing container products from plastic materials, wherein the blow-moulding, filling, sealing and separation of the filled container products from the moulded tube is carried out along a main or moulding axis which extends vertically.
